(19) United States
(12) Patent Application Publication
(10) Pub. No.: US 2007/0295865 A1
(43) Pub. Date: Dec. 27, 2007

(54) Electromagnetic Device for Generating a Force and a Torque for Positioning a Body

(75) Inventors: Massimiliano Maini, Antibes (FR); Thierry Dargent, Auribeau Sur Siagne (FR)

Correspondence Address: SUGHRUE MION, PLLC, 2100 PENNSYLVANIA AVENUE, N.W., SUITE 800, WASHINGTON, DC, 20037, US

(73) Assignee: Alcatel, Paris (FR)

(21) Appl. No.: 11/569,314

(22) PCT Filed: Apr. 25, 2005
(86) PCT No.: PCT/FR05/50275

§ 371 Date: Jun. 22, 2007

(30) Foreign Application Priority Data
May 18, 2004 (FR) 0450978

(51) Int. Cl. G05D 1/08; B64G 1/24

(52) U.S. Cl. 244/166

(57) ABSTRACT

An action device comprises first electromagnetic means installed on a first body and defining a first magnetic moment and a magnetic field and second electromagnetic means installed on a second body, distant from the first body, and defining a second magnetic moment able to interact with the magnetic field. It further comprises i) means for varying the first magnetic moment in accordance with a chosen first law of variation to cause the magnetic field to vary in time, ii) means for varying the second magnetic moment in accordance with a second law of variation so that a required force and a required torque are induced on the second body, and iii) calculation means adapted to determine the second law of variation as a function at least of the required force and the required torque and the first law of variation.

### CROSS-REFERENCE TO RELATED APPLICATIONS

This application is based on French Patent Application No. 0450978 filed 18 May 2004, the disclosure of which is hereby incorporated by reference thereto in its entirety, and the priority of which is hereby claimed under 35 U.S.C. §119.

### BACKGROUND OF THE INVENTION

1. Field of the Invention

The invention relates to devices for generating a force and a torque on a body by means of electromagnetic interaction involving a magnetic field generated for this purpose (and not an existing magnetic field, such as the terrestrial magnetic field, for example) for the purpose of precise positioning of the body.

2. Description of the Prior Art

In a number of fields a system of distant and unconnected bodies is used to effect complementary and/or shared tasks that require precise control of their relative positions and orientations. The distance between the two bodies generally varies from one application to another, as does the accuracy of control.

Here “system of bodies” means a set of at least two bodies, certain relative positions and orientations whereof must be precisely controlled. In space applications the “bodies” are satellites or probes, for example, typically intended to fly in (more or less close) formation to accomplish a mission, for example a “synthetic aperture radar” remote sensing mission or an optical interferometry mission. Of the bodies in a formation, the one that has a “central” role relative to a certain criterion is called the “hub” and any other body in the formation is called a “flyer”.

To control the positions and the orientations of the bodies, they are equipped with propulsion means (or actuators), for example chemical (cold gas) or ionic microthrusters or electrical microthrusters (such as FEEP (Field Electrical Effect Propulsion) thrusters) in which a high voltage is applied to molecules of cesium or indium to impart high velocities to them).

The drawback of the above techniques is that they induce serious constraints, such as a short service life and high overall size and weight (for example in the case of the use of a fuel) and/or a constraining arrangement (for example because of the effect of the propulsion jet and/or contamination and/or the required linearity of force control and/or the noise level and/or a narrow dynamic range).

In an attempt to solve this problem it has been proposed, in particular in U.S. Pat. No. 6,634,603, to use action devices including electromagnetic actuators for the controlled generation of forces for precise positioning of the bodies they equip. Unfortunately, these forces induce unwanted torques that must be cancelled by means of dedicated devices, such as reaction wheels, which make the bodies more complex and increase weight, overall size and cost.

No prior art action device proving entirely satisfactory, an object of the invention is therefore to improve upon the situation.

### SUMMARY OF THE INVENTION

To this end the invention proposes an action device comprising first electromagnetic means installed on at least one first body and able to define a first magnetic moment and a magnetic field and at least second electromagnetic means installed on at least one second body, distant from the first body, and able to define a second magnetic moment able to interact with the magnetic field.

The device comprises:
means for varying the first magnetic moment in accordance with a chosen first law of variation to cause the magnetic field to vary in time,
means for varying the second magnetic moment in accordance with a second law of variation so that a required force and a required torque are induced on the second body, and
calculation means adapted to determine said second law of variation as a function at least of the required force and the required torque to be induced on said second body and the chosen first law of variation.

It is important to note that a plurality of second electromagnetic means installed on a plurality of second bodies can define variable second magnetic moments that each interact locally with the variable magnetic field generated by the first electromagnetic means installed on the first body.

The first law of variation preferably defines the variation in time of the direction of the first magnetic moment at constant intensity. The means for varying the first magnetic moment are then advantageously adapted to vary its direction by rotating it about a chosen rotation axis. For example, the direction of the first moment is perpendicular to the rotation axis.

The action device according to the invention may have other, complementary features and in particular, separately and/or in combination:
its first electromagnetic means may be adapted to deliver the first magnetic moment with a constant intensity and in a constant direction; in this case, the means for varying the first magnetic moment are adapted to command the first body to turn about the rotation axis to vary the direction of the first magnetic moment,
its first electromagnetic means may include the means for varying the first magnetic moment,
its calculation means may be adapted to determine the second law of variation additionally as a function of the vector defining the position of the second body relative to the first body,
the second law of variation defines variations in time of the direction and the intensity of the second magnetic moment; for example, the means for varying the second magnetic moment are adapted to vary the direction and the intensity of the second magnetic moment synchronously with the rotation of the first magnetic moment (i.e. with the same angular frequency and the same phase), to enable “synchronous demodulation”,
its second electromagnetic means may include the means for varying the second magnetic moment; in this case, the second electromagnetic means may be fixed relative to the second body,
its first electromagnetic means may deliver a magnetic field of fixed intensity; the first body is then driven in rotation about the rotation axis in order to vary the first magnetic moment according to the first law of variation; alternatively, the first electromagnetic means cause the magnetic field to vary according to the first law of variation;
its first and second electromagnetic means may take the form of at least one coil fed with current or at least one magnet,
the intensity of the first magnetic moment is preferably high compared to the intensity of the second magnetic moment,
its calculation means may be adapted to determine the second law of variation additionally as a function of the local magnetic field; such measurements may be supplied by a magnetometer installed on the second body, for example.

The invention also proposes a system consisting of at least one first body and at least one second body comprising a distributed action device of the kind described hereinabove.

In an application in the field of space, the first and second bodies of this kind of system may be satellites or probes, for example intended to fly in close formation.

Other features and advantages of the invention will become apparent on reading the following detailed description and examining the appended drawings.

### BRIEF DESCRIPTION OF THE DRAWINGS

FIG. 1 is a diagram of one embodiment of a system according to the invention in an application to the space field.

FIG. 2 is a functional block diagram of embodiments of a “hub” and a “flyer” sharing an action device according to the invention.

FIGS. 3A to 3C are diagrams of one example of the evolution over time of three components Mx, My and Mz of a magnetic moment generated by the hub.

FIGS. 4A to 4C are diagrams of one example of the evolution over time of three components Bx, By and Bz of the magnetic field B seen locally by the flyer.

FIGS. 5A to 5C are diagrams of one example of the evolution over time of three components mx, my and mz of the magnetic moment generated by the flyer in order to produce the required force and the required torque by interaction with the local magnetic field B.

FIG. 6A is a diagram of the superposed evolution over time of the required torque (Γs), the instantaneous produced torque (Γp) and the mean torque (Γm) obtained by averaging the instantaneous produced torque (Γp) over one period of rotation of the field B.

FIG. 6B is a diagram of the superposed evolution over time of the required force (Fs), the instantaneous produced force (Fp) and the mean force (Fm) obtained by averaging the instantaneous produced force (Fp) over one period of rotation of the field B.

### DETAILED DESCRIPTION OF THE PREFERRED EMBODIMENTS

The appended drawings constitute part of the description of the invention as well as contributing to the definition of the invention, if necessary.

An object of the invention is to generate a required force and a required torque on a body belonging to a system of at least two bodies by means of electromagnetic interaction involving at least one magnetic field generated for this purpose with a view to precise positioning of that body.

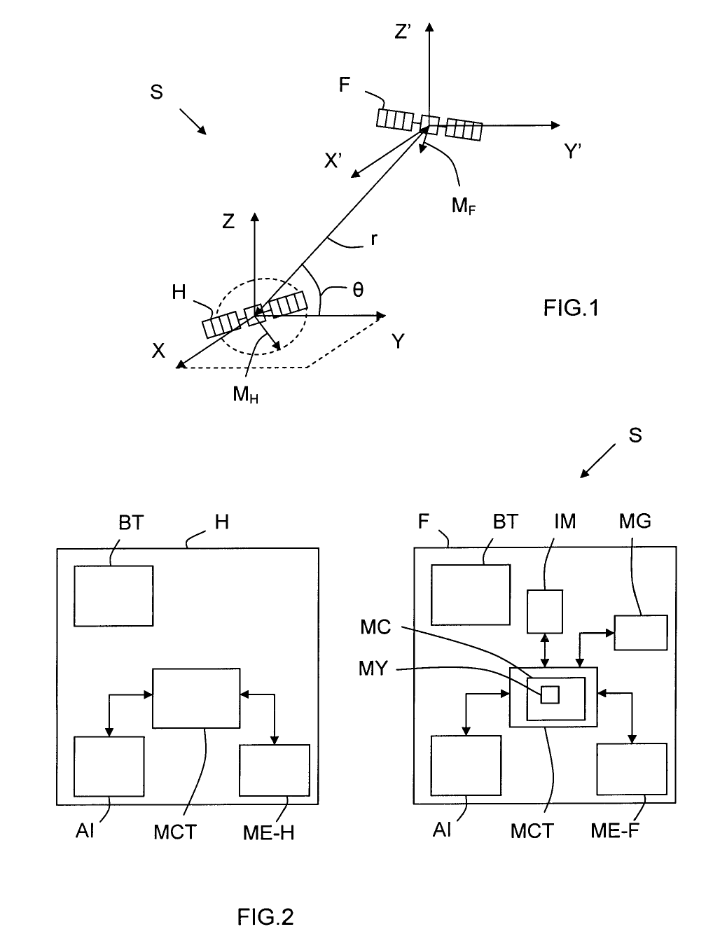

As shown in FIG. 1, the system S of bodies may for example consist of satellites flying in close formation (typically a few tens of meters apart). However, the bodies of the system S could take other forms, and in particular the form of probes.

It is considered hereinafter, by way of nonlimiting example, that the system of bodies S consists of two satellites performing a remote sensing mission, one of them, hereinafter called the hub H, having a central role and the other, hereinafter called the flyer F, being distant from the hub.

As indicated above, flying in close formation requires the setting up of a predefined geometrical configuration that often varies during a mission. In the system S described by way of example, this necessitates precise control of the position and the orientation of the flyer F relative to the hub H. It is important to note that a system including a hub H and a plurality of flyers F necessitates precise control of the positions and the orientations of the flyers relative to each other and not of those of the flyers relative to the hub.

To set up a geometrical configuration it is necessary to apply torques and forces to the various bodies of the system S and in particular to its flyers F. An action device is used for this purpose, the components whereof are divided between the various bodies (the hub H and the flyers F).

An action device according to the invention, divided between the hub H and the flyer F that constitute the system of bodies S in the example shown, is described with reference to FIGS. 1 and 2. In the presence of a plurality of flyers F, each flyer includes substantially the same components of the action device as those installed on the flyer F about to be described.

The hub(s) H and the flyer(s) F are put into orbit by a launch vehicle in one or more launches. If necessary, each body H, F uses its inertial actuators Al to move to its final position in the mission orbit. Such inertial actuators Al consist of thrusters and associated tanks containing fuel, for example. The inertial actuators Al are controlled by a control module MCT, for example.

When there is a single flyer F, as shown here, it must be precisely positioned relative to a set point system of axes, for example (to aim its remote sensing instrument at a particular region). However, as indicated above, when there is a plurality of flyers, they must be precisely positioned relative to each other to define the geometrical configuration for the mission. The action device is operative at this stage.

More precisely, it generates a required force and a required torque on each flyer F. In this example, it is considered that the hub H is correctly positioned, for example relative to a terrestrial system of axes. Consequently, the action device must control the precise positioning of the flyer F.

In this example, the action device comprises, firstly:
first electromagnetic means ME-H installed on the hub H for defining a magnetic field B by means of a magnetic dipole of magnetic moment M_{H}, and
second electromagnetic means ME-F installed on the flyer F for defining another magnetic dipole of magnetic moment M_{F} intended to interact with the magnetic field seen locally by the flyer F (consisting primarily of the magnetic field B) to induce a required force F and a required torque Γ on the flyer F (at least on average, see below).

The first electromagnetic means ME-H and the second electromagnetic means ME-F may take the form of one or more coils in which a current flows, for example, or one or more magnets, for example in a mutually perpendicular arrangement.

Three types of coils may be used: air-cored coils (i.e. coils including only a winding with no ferromagnetic core), coils including a ferromagnetic core and superconducting coils.

The intensity of the magnetic moment M_{H} is relatively high compared to that of the magnetic moment M_{F} in order for it to be possible to consider the magnetic field B produced by the first electromagnetic means ME-H to be the only magnetic field seen locally by the flyer F. This avoids magnetic interference caused by distant other sources (for example adjacent flyers in the case of an application including a hub and a plurality of flyers). In this case, a superconducting coil may be used to generate the magnetic moment M_{H} of high intensity and an air-cored coil may be used to generate the magnetic moment M_{F} of lower intensity, for example.

The first electromagnetic means ME-H and the second electromagnetic means ME-F are supplied with electrical power by an electrical power supply unit BT of their body H or F, for example a battery coupled to solar panels.

In order for each required force and each required torque to be induced on the flyer F the action device also varies (or modulates) the magnetic moment M_{H} in accordance with a chosen first law of variation (or modulation) and varies (or modulates) the magnetic moment M_{F} in accordance with a second law of variation (or modulation).

The first law of variation is preferably predetermined. For example the first law of variation defines the variation of the direction of the magnetic moment M_{H} at constant intensity.

As shown in FIG. 1, the direction of the magnetic moment MH may be varied by rotating it about a chosen rotation axis Z. In this case, it is particularly advantageous if the magnetic moment MH is at all times in a plane XY perpendicular to the rotation axis Z.

Two solutions may be envisaged for obtaining this kind of first law of variation.

A first solution uses first electromagnetic means ME-H that are fixed relative to the hub H, define a magnetic moment M_{H} of constant intensity and of fixed direction relative to a system of axes (X, Y, Z) attached to said hub H, and drive the hub H in rotation at a rotation speed (or angular frequency) ω about the axis Z of the fixed system of axes (X, Y, Z).

A second solution uses first electromagnetic means ME-H to define a magnetic moment M_{H} of constant intensity and with a direction that is varied by rotating it at a rotation speed (or angular frequency) ω about the axis Z of a fixed system of axes (X, Y, Z) attached to the flyer F.

In the latter case, the hub H does not need to be in motion. To this end, the first electromagnetic means ME-H may be either fixed relative to the hub H and to the system of axes (X, Y, Z) that is attached to it and able to produce a magnetic moment M_{H} in a direction that varies in time (i.e. that rotates) or mobile (rotatable) relative to the hub H and to the system of axes (X, Y, Z) that is attached to it and able to produce a magnetic moment M_{H} of constant direction and intensity, the rotation of the first electromagnetic means ME-H then causing the variation in time of the direction of the magnetic moment M_{H}.

According to the invention, the second law of variation is determined by a calculation module MC that is part of the action device, for example installed in the flyer F.

In the example shown in FIG. 2, the calculation module MC is installed in the control module MCT of the flyer F. However, it could be separate from the latter, or even independent of it. Moreover, this calculation module MC may take the form of electronic circuits, software (or electronic data processing) modules, or a combination of circuits and software.

More precisely, the calculation module MC determines a second law of variation of the magnetic moment M_{F} as a function at least of the required force Fs and the required torque Γ that must be induced on the flyer F by interaction between the local magnetic field (considered to be the field B) and said magnetic moment M_{F} and as a function of the first law of variation.

The required force Fs and the required torque Γs are typically calculated using a law specific to the mission and itself calculated by a dedicated calculation module (for example the control module MCT). It is therefore assumed here that the required force Fs and the required torque Γs are known to the calculation module MC.

The calculation module MC may determine the second law of variation additionally as a function of a measurement of the local magnetic field at the level of the flyer F. In this case the measurement of the local magnetic field is preferably supplied by a magnetometer MG installed in the flyer F.

However, a variant may be envisaged in which the local magnetic field seen by the flyer F at any time is considered to be the magnetic field B generated by the first electromagnetic means ME-H of the hub H. In this case, the intensity of the magnetic field B seen locally by the flyer F may be predetermined for the mission (the vector r defining the position of the flyer F relative to the hub H being considered substantially constant). In other words, the calculation module MC has a predefined model of the magnetic field seen locally by the flyer F given its position defined by the control law for the mission.

Alternatively, it may be possible to determine the intensity of the magnetic field B seen by the flyer F as a function of the aforementioned vector r. This intensity I_{B} varies with 1r³, in accordance with the formula given below, which is valid under far field conditions (i.e. far from the dipole that generates the magnetic field):

$$\vec{B} = \frac{{μ}_{0}}{4 π} \frac{3 ( {\vec{M}}_{H} , \vec{r} ) \vec{r} - {r}^{2} {\vec{M}}_{H}}{{r}^{5}}$$

in which μ⁰ is the permittivity of vacuum (i.e. 4π10⁻⁷), the vector M_{H} is the magnetic moment vector generated by the hub H, and the vector r is the aforementioned position vector.

The parameters defining the first law of variation (of the magnetic moment M_{H}) are stored in the memory MY of the calculation module MC, for example.

For accuracy, the action device may be equipped with an instrument IM capable of accurately estimating the position vector r. For example, this instrument IM is a local module using satellite positioning, for example of the GPS (Global Positioning System) type.

However, a variant may be envisaged in which the position vector r is considered known and constant. Another variant may be envisaged in which the position vector r is deduced by the calculation module MC, for example by deconvolution over a time period of the local magnetic field measurements delivered by the magnetometer MG (to be able to do this it has to know the magnetic field vector B generated by the first electromagnetic means ME-H).

The second law of variation of the magnetic moment M_{F} controls the interaction inducing the required force Fs and the required torque Γs (defined by the control law for the mission). It specifies how the direction and the intensity of the magnetic moment M_{F} must vary. As indicated above, this variation may be obtained electrically, for example, by means of three coils in an orthogonal configuration, the respective currents in which are controlled.

The local magnetic field seen by the flyer F “turns” at the same angular frequency ω as the magnetic moment M_{H} (although in general it traces an ellipse in a particular plane). Consequently, it is possible to determine a second law of variation (of the magnetic moment M_{F}) for producing the required torque and the required force on average over one rotation period of the local magnetic field starting from the position vector r and the value of the angular frequency ω (given by the first law of variation (of M_{H})), and where applicable the local magnetic field measurement and information as to the phase of the magnetic moment M_{H}. In other words, the calculation module MC effects synchronous “demodulation” to obtain the required mean force Fm and the required mean torque Γm over one period of rotation of the magnetic moment M_{F} and therefore of the magnetic field B. The second law of variation is therefore given by the combination of orthogonal (sine and cosine) components at the same angular frequency ω with the same phase Φ as the magnetic moment M_{H}.

It is useful to mention that, the averaging being effected over one rotation period, it is preferable for the magnetic field B to turn faster than the variations in the required force Fs and the required torque Γs. The instantaneous variations of the force F(t) and the torque Γ(t) are filtered by the mechanical inertia of the flyer F.

Synchronous demodulation may be effected as indicated hereinafter.

When a magnetic dipole is subjected to a magnetic field B, a torque and a force act on the dipole. Here, the magnetic field B is generated by the magnetic dipole of magnetic moment M_{H} and the magnetic dipole of magnetic moment M_{F} is subjected to this magnetic field B. The interaction force and torque are given by the following equations: Γ(M_{H},M_{F})=M_{F}xB(M_{H}), (where “x” represents a vector product), F(M_{H},M_{F})=grad(M_{F}B(M_{H}))=(M_{F}.grad)B(M_{H}), (where “.” represents a scalar product).

Also, if it is assumed that the magnetic moment M_{H} turns in the plane XY at the angular frequency ω and with a phase Φ, as shown in FIG. 1, then its vector expression may be defined as follows:

$${{\vec{M}}_{H}}_{} = {M}_{H} [ \begin{matrix}cos ( ω t + ϕ ) \\ sin ( ω t + ϕ ) \\ 0\end{matrix} ]$$

In this case, the following vector expression for the magnetic moment vector M_{F} may be used for demodulation at the angular frequency ω:

$${\vec{M}}_{F} = {M}_{F} [ \begin{matrix}{m}_{{cx}^{′}} cos ( ω t + ϕ ) + {m}_{{sx}^{′}} sin ( ω t + ϕ ) \\ {m}_{{cy}^{′}} cos ( ω t + ϕ ) + {m}_{{sy}^{′}} sin ( ω t + ϕ ) \\ {m}_{{cz}^{′}} cos ( ω t + ϕ ) + {m}_{{sz}^{′}} sin ( ω t + ϕ )\end{matrix} ]$$

where m_{ci} and mₛᵢ are respectively the cosine and sine demodulation parameters along the axis i (i=X′, Y′, Z′) in the system of axes attached to the flyer F, a function of the time concerned. Note that the phase Φ may have any value provided that it is exactly the same for M_{H} and for M_{F}.

There follows the analytical integration, over one rotation period, of the above expressions for the force F and the torque Γ, in order to obtain the expressions for the mean force Fm and the mean torque Γm as a function of the demodulation parameters (m_{ci} and mₛᵢ) This operation eliminates the temporal dependency.

The mean force Fm and the mean torque Γm over a period must be equal to the required force Fs and the required torque Γs, respectively. For example, if it is required to induce a force Fs and a torque Γs every 100 ms, the actuator is required to produce a force F and a torque Γ which over each 100 ms period are on average equal to the required force Fs and the required torque Γs over that period.

The following linear system of six equations in six unknowns (the six demodulation parameters m_{ci} and mₛᵢ) is then obtained:

$$[ \begin{matrix}{Γ}_{m} \\ {F}_{m}\end{matrix} ] = D [ \begin{matrix}{m}_{{cx}^{′}} \\ {m}_{{sx}^{′}} \\ {m}_{{cy}^{′}} \\ {m}_{{sy}^{′}} \\ {m}_{{cz}^{′}} \\ {m}_{{sz}^{′}}\end{matrix} ] = [ \begin{matrix}{Γ}_{s} \\ {F}_{s}\end{matrix} ]$$

where D is the required matrix, a function of the relative positions of the hub H and the flyer F, for changing (once inverted) from the required torque Γs and the required force Fs to the vector expression of the second magnetic moment M_{F}. It can in fact be shown that the matrix D has an analytical expression that depends on the position of the magnetic moment M_{F} relative to the magnetic moment M_{H} and therefore on the position of the flyer F relative to the hub H.

Consequently, knowing the position vector r, the calculation module MC can determine the matrix D and then determine the six demodulation parameters m_{ci} and mₛᵢ from the matrix D, the required force Fs and the required torque Γs. Using the vector relationship giving M_{F} as a function of the demodulation parameters (see above), it can then calculate the vector coordinates of the magnetic moment M_{F} that must be set at the level of the flyer F to induce the required force Fs and the required torque Γs.

Points in space at which the matrix D is singular must be proscribed, given that they correspond to positions of the flyer F in which the action device is not in a position to generate any combination of torque and force. In fact, the singular configurations correspond to situations in which the local field seen by the flyer F varies “too simply” to be able to generate any combination of torque and force (for example, when it turns in a plane).

In the example shown (corresponding to a magnetic moment M_{F} in the rotation plane XY), the singular points are all points in said plane XY and all points on the rotation axis Z of the magnetic moment M_{F}. In other words, situations in which the flyer F is positioned in the rotation plane XY or on the rotation axis Z are singular.

It is possible to reduce the number of singular positions, for example by introducing double modulation at the level of the first electromagnetic means ME-H. To this end first electromagnetic means ME-H may be used, for example, that are able to generate two magnetic moments M_{H1} and M_{H2} turning in different planes (for example the planes XY and XZ) and at different angular frequencies n₁ω and n₂ω, where n₁ and n₂ are different integers. In this case, the singularities are no longer situated only on the two rotation axes of the two magnetic moments M_{H1} and M_{H2} and on the axis of intersection of the two rotation planes of the two magnetic moments M_{H1} and M_{H2}. Of course, this significantly complicates the calculations, since it is then necessary to determine twelve demodulation parameters (m1_{ci} and m1ₛᵢ for M_{H1} and m2_{ci} and m2ₛᵢ for M_{H2}).

A variant of the previous embodiment has two hubs (H1 and H2), one of them (H1) being equipped with the first electromagnetic means (ME-H1) described above and able to generate a first magnetic moment M_{H1} turning in a first plane (for example the plane XY) and at an angular frequency n₁ω, and the other of them (H2) being equipped with third electromagnetic means (ME-H3) of the same type as the first and able to generate a third magnetic moment M_{H2} turning in a second plane (for example the plane XZ), different from the first plane, and at an angular frequency n₂ω, different from n₁ω. The interaction then occurs between the second magnetic moment M_{F} of each flyer and the two magnetic fields induced by the first magnetic moment M_{H1} and the third magnetic moment M_{H2} generated by the two hubs (H1 and H2). This further reduces the number of singular positions (since they are then limited to the intersections between the plane and the rotation axis of the first magnetic moment M_{H1} and the plane and the rotation axis of the third magnetic moment M_{H2}).

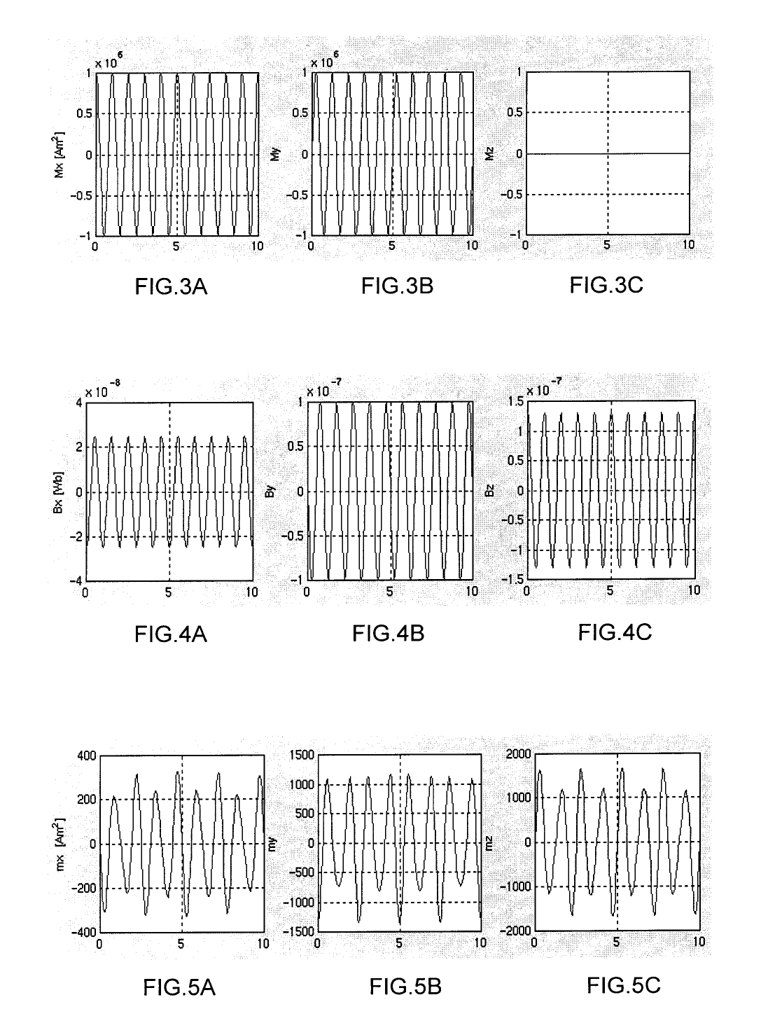

One example of the demodulation effected by the calculation module MC and its result in terms of the induced force F and the induced torque Γ is described next with reference to FIGS. 3 to 6.

More precisely, FIGS. 3A to 3C are three diagrams of one example of the evolution in time over one rotation period of the three components Mx, My and Mz, respectively, of the magnetic moment MH generated by the first electromagnetic means ME-H of the hub H in the system of axes (X, Y, Z) attached to the latter in units of Am² (ampere meter squared). Here the component Mz is a null component because the magnetic moment M_{H} turns in the plane XY.

FIGS. 4A to 4C are three diagrams of the evolution in time of the three components Bx, By and Bz, respectively, of the magnetic field B (corresponding to the magnetic moment M_{H} shown in FIGS. 3A to 3C) seen locally by the flyer F in the system of axes (X′, Y′, Z′) attached to the latter and in units of Wb (Webers). This local magnetic field example corresponds to a distance r between the hub H and the flyer F equal to 100 meters and an elevation θ of the flyer F relative to the hub H equal to 60°. Note that the azimuth is not relevant because of the symmetry about the axis Z.

FIGS. 5A to 5C are three diagrams of the evolution in time of the three components mx, my and mz, respectively, of the magnetic moment M_{F} generated by the second electromagnetic means ME-F of the flyer F in the system of axes (X′, Y′, Z′) attached to the latter (in FIG. 2 the systems of axes (X, Y, Z) and (X′, Y′, Z′) have parallel axes, but this is not obligatory) and in units of Am² (ampere meter squared), in order to produce the required force Fs and the required torque Γs by interaction with the local magnetic field, shown in FIGS. 4A to 4C.

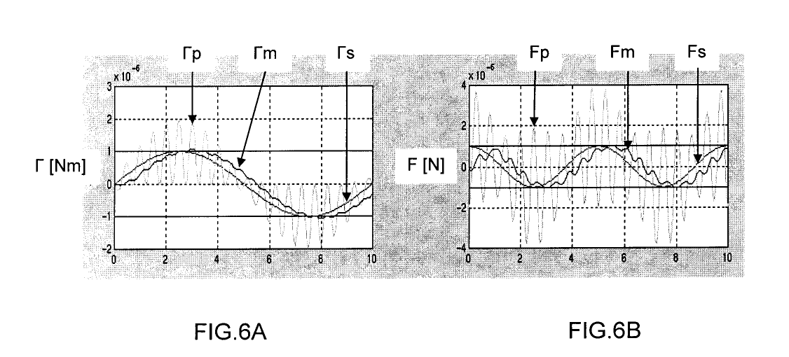

FIG. 6A is a diagram of the superposed evolutions in time, in units of Nm (Newton meters), of the required torque Γs, the instantaneous produced torque Γp and the mean torque Γm obtained by averaging the instantaneous torque Γp over one rotation period of the local magnetic field B shown in FIGS. 4A to 4C in the case of interaction between said local magnetic field B and the magnetic moment M_{F} shown in FIGS. 5A to 5C.

Finally, FIG. 6B is a diagram of the superposed evolutions over time, along the axis X′ (=X) of the system of axes (X′,Y′,Z′) attached to the flyer F and in units of N (Newtons) of the required force Fs, the instantaneous produced force Fp and the mean force Fm obtained by averaging the instantaneous produced force Fp over one period of rotation of the local magnetic field B shown in FIGS. 4A to 4C in the case of interaction between said local magnetic field B and the magnetic moment M_{F} shown in FIGS. 5A to 5C.

It is important to note that the “averaging” to obtain the mean torque Γm and the mean force Fm is in practice effected by the flyer F, because of its mechanical inertia.

And it is equally important to note that the variations in the magnetic moments M_{H} and M_{F} may be produced electrically (for example by varying the currents in coils), mechanically (for example by rotating coils), or by combining variations produced electrically and mechanically.

There is described hereinabove an embodiment of the invention in which the first law of variation (of the magnetic moment M_{H}) consists in a variation of direction (by rotation through a predetermined angle) at constant intensity and therefore independently of the required force and the required torque on the flyer F. However, determining the first law of variation locally as a function of the required force and the required torque may be envisaged. In this case, the intensity of the magnetic moment M_{H} and/or the angle may vary as a function of the required force and the required torque.

The invention is not limited to the action device, first and second body and system of bodies embodiments described hereinabove by way of example only and encompasses all variants that the person skilled in the art might envisage within the scope of the following claims.

1. An action device comprising first electromagnetic means installed on at least one first body and defining a first magnetic moment and a magnetic field and at least second electromagnetic means installed on at least one second body, distant from the first body, and defining a second magnetic moment able to interact with said magnetic field, which device comprises i) means for varying said first magnetic moment in accordance with a chosen first law of variation to cause said magnetic field to vary in time, ii) means for varying said second magnetic moment in accordance with a second law of variation so that a required force and a required torque are induced on said second body, and iii) calculation means adapted to determine said second law of variation as a function at least of the required force and the required torque to be induced on said second body and of said chosen first law of variation.

2. A device according to claim 1, wherein said first law of variation defines the variation in time of the direction of said first magnetic moment at constant intensity.

3. A device according to claim 2, characterized in that said means for varying the first magnetic moment are adapted to vary its direction by rotating it about a chosen rotation axis.

4. A device according to claim 3, characterized in that said direction is perpendicular to said rotation axis.

5. A device according to claim 1, wherein said first electromagnetic means include said means for varying the first magnetic moment.

6. A device according to claim 3, wherein said first electromagnetic means are adapted to deliver said first magnetic moment with a constant intensity and in a constant direction and said means for varying the first magnetic moment are adapted to command said first body to turn about said rotation axis to vary said direction.

7. A device according to claim 1, wherein said calculation means are adapted to determine said second law of variation additionally as a function of a vector defining the position of the second body relative to the first body.

8. A device according to claim 1, wherein said second law of variation defines variations in time of the direction and the intensity of said second magnetic moment.

9. A device according to claim 3 wherein said second law of variation defines variations in time of the direction and the intensity of said second magnetic moment, and wherein said means for varying the second magnetic moment are adapted to vary the direction and the intensity of said second magnetic moment synchronously with the rotation of the first magnetic moment.

10. A device according to claim 1, wherein said second electromagnetic means include said means for varying the second magnetic moment.

11. A device according to claim 10, wherein said second electromagnetic means are fixed relative to said second body.

12. A device according to claim 1, wherein said second electromagnetic means take the form of at least one coil fed with current or at least one magnet.

13. A device according to claim 1, wherein said first electromagnetic means take the form of at least one coil fed with current or at least one magnet.

14. A device according to claim 1, wherein the intensity of said first magnetic moment is high compared to the intensity of said second magnetic moment.

15. A device according to claim 1 wherein said calculation means are adapted to determine said second law of variation additionally as a function of the local magnetic field acting on said second body.

16. A device according to claim 15, comprising a magnetometer installed on said second body and adapted to supply said calculation means with measurements of the local magnetic field.

17. A device according to claim 1 wherein said calculation means are installed on said second body.

18. A system consisting of at least one first body and at least one second body comprising an action device according to claim 1.

19. A system according to claim 18, wherein said first body and said second body are satellites or probes intended to fly in formation.
